(19) United States
(12) Patent Application Publication
(10) Pub. No.: US 2025/0206251 A1
(43) Pub. Date: Jun. 26, 2025

(54) COLLISION MODE PREDICTION DEVICE AND OCCUPANT PROTECTANT SYSTEM

(71) Applicant: TOYOTA JIDOSHA KABUSHIKI KAISHA, Toyota-shi (JP)

(72) Inventor: Kazuki MORI, Toyota-shi (JP)

(73) Assignee: TOYOTA JIDOSHA KABUSHIKI KAISHA, Toyota-shi (JP)

(21) Appl. No.: 19/000,241

(22) Filed: Dec. 23, 2024

(30) Foreign Application Priority Data
Dec. 26, 2023 (JP) 2023-219713

(51) Int. Cl. B60R 21/0134

(52) U.S. Cl. CPC B60R 21/0134

(57) ABSTRACT

In the collision mode prediction device, the first acquisition unit acquires position information of the own vehicle. The second acquisition unit acquires position information of another vehicle. When there is a possibility of a collision between the own vehicle and another vehicle, the prediction unit predicts a collision mode between the own vehicle and the other vehicle on the basis of the position information of the own vehicle and the position information of the other vehicle.

### CROSS-REFERENCE TO RELATED APPLICATION

This application claims priority to Japanese Patent Application No. 2023-219713 filed on Dec. 26, 2023, incorporated herein by reference in its entirety.

### BACKGROUND

### 1. Technical Field

The disclosure relates to a collision mode prediction device and an occupant protection system.

### 2. Description of Related Art

Japanese Unexamined Patent Application Publication No. 2004-009830 (JP 2004-009830 A) discloses a collision mode determination device including right and left front sensors attached to right and left front portions of a vehicle, to detect right and left deceleration in a front-rear direction. In this device, the right and left deceleration detected by the right and left front sensors is used to detect that the vehicle is in a collision state, and also to determine whether the vehicle is a symmetrical collision such as a front-on collision or the like, or an asymmetrical collision.

### SUMMARY

In the technology of JP 2004-009830 A, two acceleration sensors are provided as the right and left front sensors, but it is conceivable to reduce the number of acceleration sensors to one, for the sake of cost reduction. However, a collision mode cannot be determined by one acceleration sensor.

An object of the disclosure is to provide technology capable of predicting a collision mode between an own vehicle and another vehicle.

In order to solve the above problem, a collision mode prediction device according to an aspect of the disclosure includes:
a first acquisition unit that acquires position information of an own vehicle,
a second acquisition unit that acquires position information of another vehicle, and
a prediction unit that, when collision between the own vehicle and the other vehicle is likely, predicts a collision mode between the own vehicle and the other vehicle, based on the position information of the own vehicle and the position information of the other vehicle.

Another aspect of the disclosure is an occupant protection system. The occupant protection system includes
a first acquisition unit that acquires position information of an own vehicle,
a second acquisition unit that acquires position information of another vehicle,
a prediction unit that, when collision between the own vehicle and the other vehicle is likely, predicts a collision mode between the own vehicle and the other vehicle, based on the position information of the own vehicle and the position information of the other vehicle,
an acceleration sensor that is installed in a middle portion of a front portion of the own vehicle, and
a control unit for controlling operation of an airbag of the own vehicle, based on a comparison result between acceleration detected by the acceleration sensor, and a threshold value set in accordance with the collision mode that is predicted.

According to the disclosure, technology can be provided that is capable of predicting a collision mode between an own vehicle and another vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram illustrating a situation in which symmetrical collisions are likely to occur;

FIG. 1B shows situations where asymmetric collisions are likely to occur;

FIG. 2 is a block-diagram illustrating a functional configuration of the occupant protection system according to the embodiment; and

FIG. 3 is a flowchart illustrating an operation of the collision mode prediction unit of FIG. 2.

### DETAILED DESCRIPTION OF EMBODIMENTS

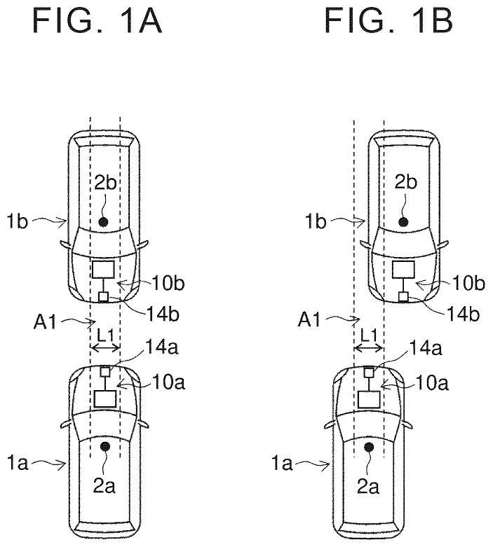

FIGS. 1A and 1B are diagrams for describing the operation of the occupant protection system according to the embodiment. FIGS. 1A and 1B illustrate a state immediately before the first vehicle 1a and the second vehicle 1b collide in front while the second vehicle 1b is traveling toward the first vehicle 1a from the front direction of the first vehicle 1a during traveling. Hereinafter, the first vehicle 1a and the second vehicle 1b will be collectively referred to as the vehicle 1 as appropriate.

FIG. 1A shows situations in which symmetric collisions are likely to occur. FIG. 1B shows situations where asymmetric collisions are likely to occur. The collision of substantially all of the front surface of the vehicle body of the vehicle 1 with the object to be collided is referred to as a symmetrical collision. Symmetric collisions can also be referred to as full-wrap collisions. Further, a collision of a part of the vehicle body front surface of the vehicle 1 with a collision target object is referred to as an asymmetric collision. Asymmetric collisions may also be referred to as offset collisions.

The first vehicle 1a comprises a first occupant protection system 10a. The first occupant protection system 10a includes an acceleration sensor 14a and an airbag (not shown). The acceleration sensor 14a is mounted in a central portion of a front portion of the first vehicle 1a. The second vehicle 1b comprises a second occupant protection system 10b. The second occupant protection system 10b includes an acceleration sensor 14b and an airbag (not shown). Hereinafter, the first occupant protection system 10a and the second occupant protection system 10b will be collectively referred to as the occupant protection system 10 as appropriate.

The first occupant protection system 10a and the second occupant protection system 10b are directly communicable using inter-vehicle communication. The first occupant protection system 10a and the second occupant protection system 10b have the same configuration and function. Therefore, the first occupant protection system 10a will be described below. Note that the second occupant protection system 10b may execute occupant protection by a configuration and a function that differ from the first occupant protection system 10a as long as the position information of the second vehicle 1b can be transmitted to the first vehicle 1a using the inter-vehicle communication.

In the context of FIGS. 1A and 1B, the first occupant protection system 10a of the first vehicle 1a determines whether there is a possibility of colliding with the second vehicle 1b using a radar (not shown) or the like. If it is determined that there is a possibility of collision with the second vehicle 1b, the first occupant protection system 10a acquires position data of the second vehicle 1b from the second vehicle 1b by inter-vehicle communication prior to the collision.

Subsequently, the first occupant protection system 10a identifies, prior to the collision, the positional relationship between the center 2a of the first vehicle 1a and the center 2b of the second vehicle 1b based on the positional information of the first vehicle 1a and the positional information of the second vehicle 1b, and predicts that the collision mode is a symmetrical collision when the identified positional relationship satisfies a predetermined criterion. The first occupant protection system 10a predicts that the collision mode is an asymmetric crash if the identified positional relation does not meet the criterion. Details of the criterion will be described later.

In the example of FIG. 1A, the first occupant protection system 10a predicts a symmetric collision and sets the operating condition of the airbag to a condition that matches the symmetric collision prior to the collision. After the conditions of FIG. 1A, the first occupant protection system 10a activates the airbag when the first vehicle 1a and the second vehicle 1b collide and the acceleration detected by the acceleration sensor 14a satisfies the activation condition.

In the example of FIG. 1B, the first occupant protection system 10a predicts an asymmetric collision and sets the operating condition of the airbag to a condition that matches the asymmetric collision prior to the collision. After the conditions of FIG. 1B, the first occupant protection system 10a activates the airbag when the first vehicle 1a and the second vehicle 1b collide and the acceleration detected by the acceleration sensor 14a satisfies the activation condition.

As described above, according to the embodiment, it is possible to predict the collision mode of the own vehicle and the other vehicle before the collision based on the position information without using the acceleration. Therefore, there is no need to determine the collision mode based on the difference between the left and right accelerations by installing two acceleration sensors in the front portion of the vehicle 1, and the airbag can be appropriately deployed according to the predicted collision mode by using one acceleration sensor 14a in the front portion of the vehicle 1. Hereinafter, embodiments will be described in more detail. Hereinafter, the first vehicle 1a in FIGS. 1A and 1B is also referred to as an own vehicle, and the second vehicle 1b is also referred to as another vehicle.

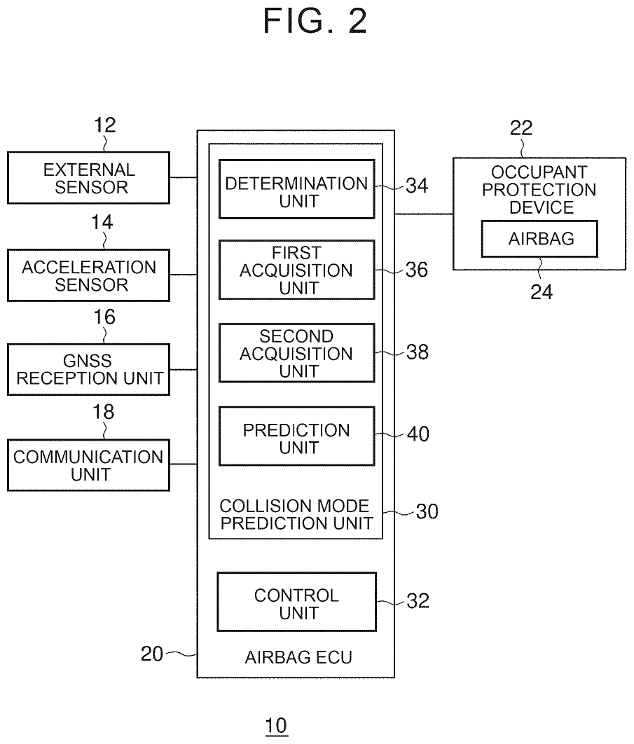

FIG. 2 is a block diagram illustrating a functional configuration of the occupant protection system 10 according to the embodiment. The occupant protection system 10 includes an external sensor 12, an acceleration sensor 14, a GNSS (Global Navigation Satellite System) reception unit 16, a communication unit 18, an airbag ECU (Electronic Control Unit) 20, and an occupant protection device 22.

The external sensor 12 detects a target such as a moving object or an obstacle by the reflected radio wave of the radio wave transmitted to the surroundings of the own vehicle. The external sensor 12 includes, for example, a laser radar or a millimeter wave radar. In the case of a millimeter-wave radar, the external sensor 12 detects a target located in front of or on the front side of the own vehicle by transmitting and receiving a radar wave in a frequency-modulated millimeter-wave band, and generates information on the target, such as the position and speed of the target, based on the detection result. The external sensor 12 may include a camera that captures an image of a front side and a front side of the own vehicle in place of or in addition to the radar, and may generate information on a target based on the captured image. The external sensor 12 outputs information about the detected target to the airbag ECU 20.

The acceleration sensor 14 is for collision detection, and is installed in a central portion of a front portion of the own vehicle. For example, the acceleration sensor 14 is fixed to a central portion of an upper member of the radiator support. The acceleration sensor 14 detects an acceleration in the front-rear direction of the vehicle and outputs information on the detected acceleration to the airbag ECU 20. Hereinafter, the acceleration in the vehicle rear direction is defined as a positive value. The acceleration detected by the acceleration sensor 14 is used to determine whether or not to deploy the airbag.

In the occupant protection system 10, in addition to the acceleration sensor 14, an acceleration sensor for collision detection is not provided in the front portion of the own vehicle. Since only one acceleration sensor 14 for collision detection needs to be provided at the front portion of the own vehicle, the cost of the acceleration sensor can be reduced as compared with a known configuration in which two acceleration sensors are provided at the left and right of the front portion of the own vehicle.

The occupant protection system 10 may include a known floor sensor (not shown) installed on a floor constituting a vehicle cabin of the own vehicle. The floor sensor also detects acceleration in the front-rear direction of the vehicle, and outputs information on the detected acceleration to the airbag ECU 20. The acceleration detected by the floor sensor may also be used to determine whether to deploy the airbag.

GNSS reception unit 16 receives a signal from the satellites and periodically derives the position of the own vehicle based on the received signal. The position of the own vehicle includes latitude and longitude. GNSS reception unit 16 outputs the derived position data to the airbag ECU 20. GNSS reception unit 16 may include, for example, a GPS (Global Positioning System) receiver.

The communication unit 18 exchanges information with a communication unit of another vehicle by inter-vehicle communication using an infrared laser or a radio wave. The communication unit 18 receives the position information of the own vehicle derived by GNSS reception unit 16 via the airbag ECU 20, and transmits the positional information to the communication unit of the other vehicle. Vehicle ID for identifying a vehicle to be a transmitting source is attached to the transmitted position data. Further, the communication unit 18 receives the position information of the other vehicle from the communication unit of the other vehicle, and outputs the received position information to the airbag ECU 20. A vehicle ID for identifying the other vehicle is attached to the position data of the other vehicle.

The communication unit 18 may exchange position information with a communication unit of another vehicle via a server device (not shown).

The occupant protection device 22 includes an airbag 24 that can be deployed in a vehicle cabin of the own vehicle. The occupant protection device 22 activates the airbag 24 when an activation signal is supplied from the airbag ECU 20. Various known configurations can be used as the occupant protection device 22.

The airbag ECU 20 includes a collision mode prediction unit 30 and a control unit 32. The airbag ECU 20 may also be referred to as a controller. The collision mode prediction unit 30 includes a determination unit 34, a first acquisition unit 36, a second acquisition unit 38, and a prediction unit 40. The collision mode prediction unit 30 corresponds to a collision mode prediction device.

The configuration of the airbag ECU 20 may be realized by hardware, a CPU of any computer, a memory, or another LSI, and may be realized by software, a program loaded into the memory, or the like. However, the functional blocks realized by the cooperation are illustrated here. Accordingly, those skilled in the art will appreciate that these functional blocks can be implemented in various forms by hardware only, software only, or a combination thereof.

The determination unit 34 derives a collision time between the own vehicle and another vehicle based on the information on the target supplied from the external sensor 12 and the vehicle information of the own vehicle. The vehicle information of the own vehicle includes speed and the like, and is acquired from various in-vehicle sensors (not shown) and the like. For example, TTC (Time To Collision) and the like can be used as the collision times. The determination unit 34 determines whether or not there is a possibility of a collision between the own vehicle and another vehicle based on TTC or the like, and outputs the determination result to the first acquisition unit 36, the second acquisition unit 38, and the prediction unit 40. The possibility of a collision is, for example, the possibility of a frontal collision. Various known techniques can be used to determine the likelihood of a collision.

When the determination unit 34 determines that there is a possibility of a collision between the own vehicle and another vehicle, the first acquisition unit 36 acquires the position information of the own vehicle from GNSS reception unit 16, and supplies the acquired position information to the prediction unit 40.

The second acquisition unit 38 includes, for example, positional relationship information of a plurality of vehicles created by a known technology of vehicle-to-vehicle communication. The positional relation information includes a position of the own vehicle, and information on a position and a vehicle ID of another vehicle around the own vehicle. The second acquisition unit 38 periodically acquires the position information of the own vehicle from GNSS reception unit 16, periodically acquires the position information of the other vehicle and the vehicle ID from the other vehicles in the vicinity of the own vehicle through the communication unit 18, and periodically updates the positional relation information.

When the determination unit 34 determines that there is a possibility of a collision between the own vehicle and another vehicle, the second acquisition unit 38 acquires position information of another vehicle that is likely to collide, and supplies the acquired position information to the prediction unit 40.

For example, when it is determined that there is a possibility of a collision between the own vehicle and another vehicle, the second acquisition unit 38 estimates another vehicle having a possibility of a collision located in the immediate vicinity of the front of the own vehicle on the basis of the positional relationship information, identifies the estimated vehicle ID of the other vehicle, and the communication unit 18 specifies the identified vehicle ID and transmits a request for the positional information. In this case, the communication unit of the vehicle having the designated vehicle ID transmits the most recent position information according to the received request. The communication unit 18 of the own vehicle receives the position information from another vehicle that is likely to collide, and the second acquisition unit 38 acquires the position information from the communication unit 18. In this case, even if the update frequency of the positional relationship information is lower than the determination frequency of the collision possibility, it is possible to acquire the latest positional information of another vehicle that is likely to collide.

Alternatively, the update frequency of the positional relationship information may be equal to the determination frequency of the possibility of collision. When it is determined that there is a possibility of collision between the own vehicle and the other vehicle, the second acquisition unit 38 may estimate the other vehicle having a possibility of collision based on the positional relationship information, and may acquire the estimated positional information of the other vehicle from the positional relationship information. In this case, since it is not necessary to communicate with another vehicle after it is determined that there is a possibility of a collision, it becomes easier to acquire the latest position information of another vehicle that is likely to collide in a shorter time.

The second acquisition unit 38 may acquire position information of another vehicle that may collide with each other by using another known technology of vehicle-to-vehicle communication. For example, the second acquisition unit 38 may not have the positional relationship information, and the communication unit 18 may transmit a request for the positional information to the front of the own vehicle without specifying the destination vehicle by using an infrared laser when it is determined that there is a possibility of a collision between the own vehicle and another vehicle. The direction and range in which the request is transmitted can be determined as appropriate by experiment or simulation. The communication unit of the vehicle that has received the request transmits the latest position information in accordance with the received request.

When there is a possibility of a collision between the own vehicle and another vehicle, the prediction unit 40 predicts the collision mode between the own vehicle and the other vehicle on the basis of the position information of the own vehicle acquired by the first acquisition unit 36 and the position information of the other vehicle acquired by the second acquisition unit 38 before the own vehicle and the other vehicle collide with each other, and outputs the prediction result to the control unit 32.

When the positional relationship between the center of the own vehicle and the center of the other vehicle, which is identified based on the positional information of the own vehicle and the positional information of the other vehicle, satisfies the criterion, the prediction unit 40 predicts that the collision mode is a symmetrical collision.

As shown in FIG. 1A, the prediction unit 40 determines that the positional relation between the center 2a of the own vehicle and the center 2b of the other vehicle satisfies the criterion, for example, when the center 2b of the other vehicle is located within the area Al of the predetermined width L1 passing through the center 2a of the own vehicle in the vehicle front-rear direction. The area Al is an area between the two dashed lines in FIG. 1A, and is a rectangular area extending parallel to the front-rear direction of the vehicle. The center 2a of the own vehicle is located at the center of the area Al in the vehicle widthwise direction.

The predetermined width L1 is narrower than the vehicle width of the own vehicle. The predetermined width L1 can be determined as appropriate by experimentation or simulations depending on the symmetrical collision and the range of collision to be performed.

When the positional relationship between the center of the own vehicle and the center of another vehicle does not satisfy the criterion, the prediction unit 40 predicts that the collision mode is an asymmetric collision.

As shown in FIG. 1B, the prediction unit 40 determines that the positional relationship between the center 2a of the own vehicle and the center 2b of the other vehicle does not satisfy the criterion, for example, when the center 2b of the other vehicle is not located within the area Al of the predetermined width L1 passing through the center 2a of the own vehicle in the vehicle front-rear direction.

Return to FIG. 2. The control unit 32 controls the operation of the airbag 24 of the own vehicle based on the comparison result between the acceleration detected by the acceleration sensor 14 and the threshold value set according to the collision mode predicted by the prediction unit 40.

The control unit 32 sets the threshold value to the first threshold value when the collision mode is predicted to be a symmetrical collision, and activates the airbag 24 when the acceleration detected by the acceleration sensor 14 becomes equal to or greater than the first threshold value. As a result, the airbag 24 is deployed.

The control unit 32 sets the threshold value to the second threshold value when the collision mode is predicted to be an asymmetric collision, and activates the airbag 24 when the acceleration detected by the acceleration sensor 14 becomes equal to or higher than the second threshold value. The second threshold value is different from the first threshold value, for example, smaller than the first threshold value.

In the asymmetric collision, unlike the case where the time waveform of the acceleration at the time of the collision detected by the acceleration sensor 14 is the symmetric collision, the peak value of the time waveform of the acceleration is smaller than that in the case of the symmetric collision, and the rise of the time waveform of the acceleration may be slower than that in the case of the symmetric collision. Thus, in an asymmetric collision, the time from the moment of collision until the acceleration reaches the first threshold may be longer than in the case of a symmetric collision. In the embodiment, since the second threshold value is smaller than the first threshold value, the timing of activating the airbag 24 in the case of an asymmetric collision can be advanced as compared with the case where the first threshold value is used. Therefore, even in the case of an asymmetric collision, the time from the moment of collision until the airbag 24 starts deployment can be made equal to that in the case of a symmetric collision.

The initial threshold value may be a first threshold value. The control unit 32 activates the airbag 24 when the acceleration detected by the acceleration sensor 14 becomes equal to or greater than the first threshold value even when the collision mode is not predicted. Thus, the airbag 24 can be deployed even in a case where the collision mode cannot be predicted by the prediction unit 40 due to, for example, the failure to acquire the position information of the other vehicle.

Note that the control unit 32 may adopt other known operating conditions as long as the operating conditions of the airbag 24 are different depending on whether the predicted collision mode is a symmetrical collision or an asymmetrical collision.

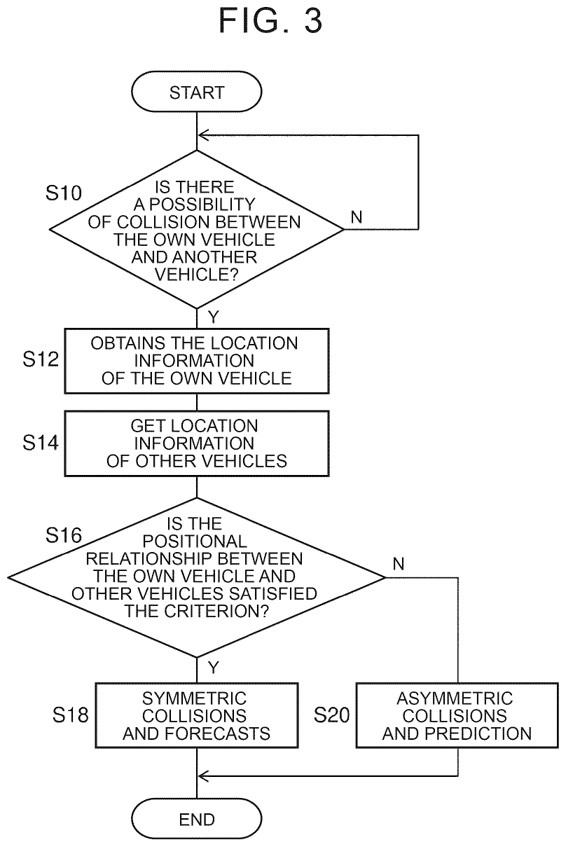

Next, the overall operation of the collision mode prediction unit 30 having the above-described configuration will be described. FIG. 3 is a flowchart showing an operation of the collision mode prediction unit 30 of FIG. 2. In parallel with the process of FIG. 3, the process of determining whether to activate the airbag 24 by the control unit 32 is periodically repeated at a predetermined cycle.

The determination unit 34 determines whether or not there is a possibility of a collision between the own vehicle and another vehicle (S10). If there is no possibility of a collision (N in S10), the determination unit 34 returns to S10 process. If there is a possibility of a collision (Y in S10), the first acquisition unit 36 acquires the position information of the own vehicle (S12), the second acquisition unit 38 acquires the position information of the other vehicle (S14), and the prediction unit 40 determines whether the positional relation between the own vehicle and the other vehicle satisfies the criterion (S16). When the positional relation between the own vehicle and the other vehicle satisfies the criterion (Y in S16), the prediction unit 40 predicts a symmetrical collision (S18), and the collision mode prediction unit 30 ends the process. When the positional relation between the own vehicle and the other vehicle does not satisfy the criterion (N in S16), the prediction unit 40 predicts an asymmetric collision (S20), and the collision mode prediction unit 30 ends the process.

The present disclosure has been described above based on the embodiments. It will be understood by those skilled in the art that the embodiments are merely illustrative, and that various modifications can be made to the respective components and combinations of the respective processing processes, and that such modifications are within the scope of the present disclosure.

For example, the prediction unit 40 may predict the collision mode based on the positional relationship between the center of the own vehicle immediately before the collision and the center of the other vehicle, and also based on the traveling direction of the own vehicle immediately before the collision and the traveling direction of the other vehicle. If it is determined that there is a possibility of a collision between the own vehicle and another vehicle, the first acquisition unit 36 further acquires information on the traveling direction of the own vehicle from GNSS reception unit 16, and also supplies the acquired information on the traveling direction to the prediction unit 40. When it is determined that there is a possibility of a collision between the own vehicle and the other vehicle, the second acquisition unit 38 further acquires information on the traveling direction of the other vehicle that is likely to collide, and also supplies the acquired information on the traveling direction to the prediction unit 40. When the positional relationship between the center of the own vehicle and the center of the other vehicle satisfies the criterion and the traveling direction of the own vehicle and the traveling direction of the other vehicle satisfy another criterion, the prediction unit 40 predicts that the collision mode is a symmetrical collision. For example, when the traveling direction of the other vehicle is a deviation less than the predetermined angle with respect to the traveling direction of the own vehicle, the prediction unit 40 determines that the traveling direction of the own vehicle and the traveling direction of the other vehicle satisfy another criterion. The predetermined angle can be appropriately determined by experiment or simulation. When the positional relationship between the center of the own vehicle and the center of the other vehicle does not satisfy the criterion, or when the traveling direction of the own vehicle and the traveling direction of the other vehicle do not satisfy another criterion, the prediction unit 40 predicts that the collision mode is an asymmetric collision. According to this modification, even if the positional relationship between the center of the own vehicle and the center of the other vehicle satisfies the criterion, if there is a high possibility that the other vehicle will collide obliquely with the own vehicle, it is possible to predict that the collision is an asymmetric collision, and thus it is easy to improve the prediction accuracy of the collision mode.

What is claimed is:

1. A collision mode prediction device comprising:
a first acquisition unit that acquires position information of an own vehicle;
a second acquisition unit that acquires position information of another vehicle; and
a prediction unit that, when collision between the own vehicle and the other vehicle is likely, predicts a collision mode between the own vehicle and the other vehicle, based on the position information of the own vehicle and the position information of the other vehicle.

2. The collision mode prediction device according to claim 1, wherein the prediction unit
predicts that the collision mode is a symmetrical collision, when a positional relation between a center of the own vehicle and a center of the other vehicle, that are identified based on the positional information of the own vehicle and the positional information of the other vehicle, satisfies a predetermined criterion, and
predicts that the collision mode is an asymmetrical collision, when the positional relation between the center of the own vehicle and the center of the other vehicle does not satisfy the criterion.

3. The collision mode prediction device according to claim 2, wherein, when the center of the other vehicle is situated in a region of a predetermined width passing through the center of the own vehicle in a vehicle front-rear direction, the prediction unit determines that the positional relations between the center of the own vehicle and the center of the other vehicle satisfies the criterion.

4. An occupant protection system comprising:
a first acquisition unit that acquires position information of an own vehicle;
a second acquisition unit that acquires position information of another vehicle;
a prediction unit that, when collision between the own vehicle and the other vehicle is likely, predicts a collision mode between the own vehicle and the other vehicle, based on the position information of the own vehicle and the position information of the other vehicle;
an acceleration sensor that is installed in a middle portion of a front portion of the own vehicle; and
a control unit for controlling operation of an airbag of the own vehicle, based on a comparison result between acceleration detected by the acceleration sensor, and a threshold value set in accordance with the predicted collision mode.

5. The occupant protection system according to claim 4, wherein no acceleration sensor for collision detection is provided in the front portion other than the acceleration sensor.
